(19) United States
(12) Patent Application Publication
(10) Pub. No.: US 2010/0251438 A1
(43) Pub. Date: Sep. 30, 2010

(54) MICROSCOPY CONTROL SYSTEM AND METHOD

(75) Inventors: Heinrich Huber, Dublin (IE); Heiko Dussmann, Dublin (IE); Paul Perrine, Maynooth (IE); Jakub Wenus, Maynooth (IE); Dimitrios Kalamatianos, Dublin (IE); Maximilian Wuerstle, Spielberg (DE)

Correspondence Address: WITHROW & TERRANOVA, P.L.L.C., 100 REGENCY FOREST DRIVE, SUITE 160, CARY, NC, 27518, US

(73) Assignees: THE ROYAL COLLEGE OF SURGEONS IN IRELAND, Dublin (IE); NATIONAL UNIVERSITY OF IRELAND MAYNOOTH, Maynooth (IE)

(21) Appl. No.: 12/725,013

(22) Filed: Mar. 16, 2010

(30) Foreign Application Priority Data
Mar. 25, 2009 (IE) S2009/0230

(51) Int. Cl. G01Q 10/02

(52) U.S. Cl. 850/1

(57) ABSTRACT

A method for controlling laser scanning microscopy of a probe comprising at least one cell is disclosed. The method comprises the steps of acquiring at least one initial image of the probe and identifying at least one cell within an initial probe image. Using a pre-defined grammar, a first set of scanning mode parameters for monitoring the cell(s); a first set of trigger parameters including at least one physiological parameter defining an event in the cell(s); and a second set of scanning mode parameters for monitoring at least one cell of the probe after an occurrence of the event is defined. A successive set of probe images acquired according to the first set of scanning mode parameters is provided and processed to determine if the event has occurred. Responsive to the event occurring, microscope modality is changed to the second set of scanning mode parameters.

This application claims priority to Irish application S2009/0230 filed Mar. 25, 2009, the disclosure of which is incorporated herein by reference in its entirety.

### FIELD OF THE INVENTION

This invention relates to a method and system for automated control of laser scanning microscopy.

### BACKGROUND

Microscopy of living cells is heavily used in modern research to understand cellular processes and drug action in cell tissue. Artificial fluorescent dyes and also fluorescent proteins can be excited in volumes down to the resolution limit by microscopy lasers to support the visualization of events that can be identified by changes in fluorescent intensity and can in turn be studied by a biologist.

Different events may require different set-ups for an experiment including selecting: dyes, laser excitation and detection channels, sampling speed and spatial magnification, all being influenced by the biologist's view of the underlying process.

However, the laser light employed in microscopy can harm the cell before a desired event occurs, a process known as phototoxicity. As experiments may run for hours or days, manpower restrictions apply when controlling and evaluating the experiments. For example, studies in cell proliferation or apoptosis, involve the detection of time sequence of several spontaneous and dependent events, may last up to several days and can require continuous supervision. Likewise, the cell's sensitivity to phototoxicity requires that laser resources be used efficiently. This poses a challenge whenever key events happen spontaneously after hours and then proceed rapidly. Here, overly frequent temporal sampling might lead to premature photoxicity, while infrequent sampling might result in poor temporal resolution of the events under investigation.

In the literature, PCT Application WO 01/094528 discloses automatic XYZ position alteration of an optical microscope during the course of an experiment.

Rabut, G. and J. Ellenberg. 2004 “Automatic real-time three-dimensional cell tracking by fluorescence microscopy”, J Microsc 216:131-137 discloses automated focus and XYZ location responsive to cell changes in fluorescence microscopy, referred to as 3D cell Tracking.

Separately, PCT Application WO 2008/028944, discloses a microscopic system for scanning a sample that allows the detection of interesting events at certain regions of a sample and adapting imaging modalities based on the results of this analysis, including the results of multiple positions.

Separately again, the Zeiss Visual Macro Editor can be used to automate scanning strategy in fluorescence microscopy based on one image parameter—intensity of a predefined region of interest (no tracking)—and by comparing only one image with another.

### SUMMARY OF THE INVENTION

According to the present invention there is provided a method according to claim 1.

The present invention uses image analysis of time series comprising multiple images returned from a laser scanning microscope to detect biological events within a probe, and to respond to, for example, changes in average, standard deviation or total intensity or to distribution and patterns of probe signals to alter microscope modality.

These signals can be interpreted and lead to change in imaging channels (which includes setup of excitation and detection laser channels, light path set-ups including mirrors), threshold level, analysis area, focus, magnification, sampling rate etc.

The present invention combines single cell microscopy, image analysis and automation in a way that allows microscope modality adaptation in response to cell signaling events as detected by physical, physiological, biochemical or morphological changes in cells over time. Cells may include all cells including animal or plant tissue, mutant and aberrant cells like cancer cells, as well as specialized cells such as liver, muscle cells or neurons.

Embodiments of the invention allow for the simultaneous detection of events from multiple positions within a sample with overlapping or non-overlapping areas, processing this information separately or in combination to decide on microscopy actions.

The invention enables automation of the data acquisition process at the microscope using laser excitation and imaging resources efficiently, and tailored to the stage of the experiment when they are actually required.

Embodiments of the invention employ image analysis including cell segmentation and cell tracking to generate time series of fluorescent signals within cells. These signals are compared to a-priori user defined criteria, which lead to a change of microscope modality. Signals can generate triggers alone or in combination with other signals from the same or from different cells and from cells from different regions of the sample

The invention uses a-priori knowledge of a biological process under investigation to automate microscopy by adapting sampling rates and other microscope modalities like lasers resources, detection settings, optical path settings, stage position, focus position, region of interest, image resolution, scan speed, z-stack measurements, photo-bleaching, un-caging, fluorescence lifetime imaging, fluorescence correlation spectroscopy, optical tweezers, or magnification during the course of an experiment.

In some implementations of the invention, many different microscopy devices may be available on the same stage (if provided) and the invention could enable a switch from one to two photon excitation microscopy or any other microscopy method using non-linear excitation, from point to line scan or spinning disk for fast 3D imaging, to super resolution microscopy like STED (Stimulated Emission Depletion), PALM (Photo-Activated Localisation Microscopy) or STORM (Stochastic Optical Reconstruction Microscopy), to TIRF or structured illumination (e.g. Apotome, Vivatome, Axiovision), to Raman microscopy to FTIR (Fourier Transform Infra Red) microscopy.

Some implementations of the invention allow parts of the hardware not required in an experiment anymore to be switched off (to increase hardware lifetime) or to switch to a next sample.

In other implementations, an email/notification to a user could be sent indicating, for example, that an experiment is finished, the incubation temperature, the atmosphere or the buffer could be changed, the latter using automated valves especially for CLEM (Correlated Light and Electron Microscopy) to fixation reagent/certain dyes and fluorescent probes.

Embodiments of the invention provide a graphical description language that allows the course of an experiment to be governed by a grammar that involves data structures and code entities defining any criteria and subsequent modality control actions. In some implementations, the language governing the control of an experiment can be defined in XML (eXtensible Markup Language).

This graphical description language is readily applicable to a large range of biological applications.

The present invention provides a system that uses online evaluation of temporal intra-cellular signals combined with a criteria-based decision system that adaptively changes microscope modality based on a priori biological knowledge.

In the embodiment, the system architecture separates the definition of the biological process from the execution logic. By separating the microscope drivers from the process logic, the system architecture is suited to include legacy equipment.

### BRIEF DESCRIPTION OF THE DRAWINGS

An embodiment of the invention will now be described, by way of example, with reference to the accompanying drawings, in which:

FIG. 1 is a schematic diagram showing the architecture for a system for automated control of laser scanning microscopy according to a preferred embodiment of the invention;

FIG. 2 is a universal modeling language (UML) diagram of a data structure used within a graphical framework component of the apparatus of FIG. 1;

FIG. 3 illustrates an exemplar graphical framework definition for an experiment controlled according to an embodiment of the present invention;

FIG. 4 illustrates a schema for handling multiple fields of view within the base system of FIG. 1 by switching between a single process control screener (PCS) and multiple image acquisition support (IAS); and

FIG. 5 illustrates an application of the invention in the study of electrophysiological changes in neurons.

### DESCRIPTION OF THE PREFERRED EMBODIMENTS

In a first aspect of the present embodiment, image analysis techniques are used for cell segmentation and tracking to extract time series of fluorescent signals from cells under laser scanning microscopy analysis. As these signal changes indicate biologically relevant information, their changes are compared to user-defined criteria. These are subsequently used as triggers to adapt microscope modalities including sampling rates, laser excitation, magnification, during single cell measurements.

In a further aspect of the present embodiment, a graphical framework is provided to enable the application of the above criteria based mechanism to a large class of single cell experiments. This allows the time course of an experiment to be determined through criteria and subsequent control actions, based on a-priori biological models of the experiment.

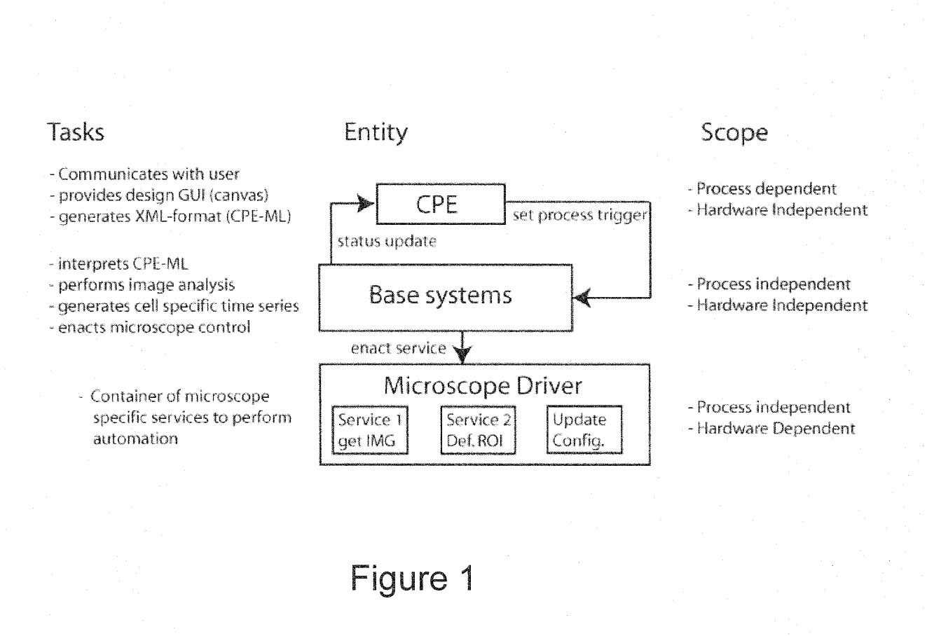

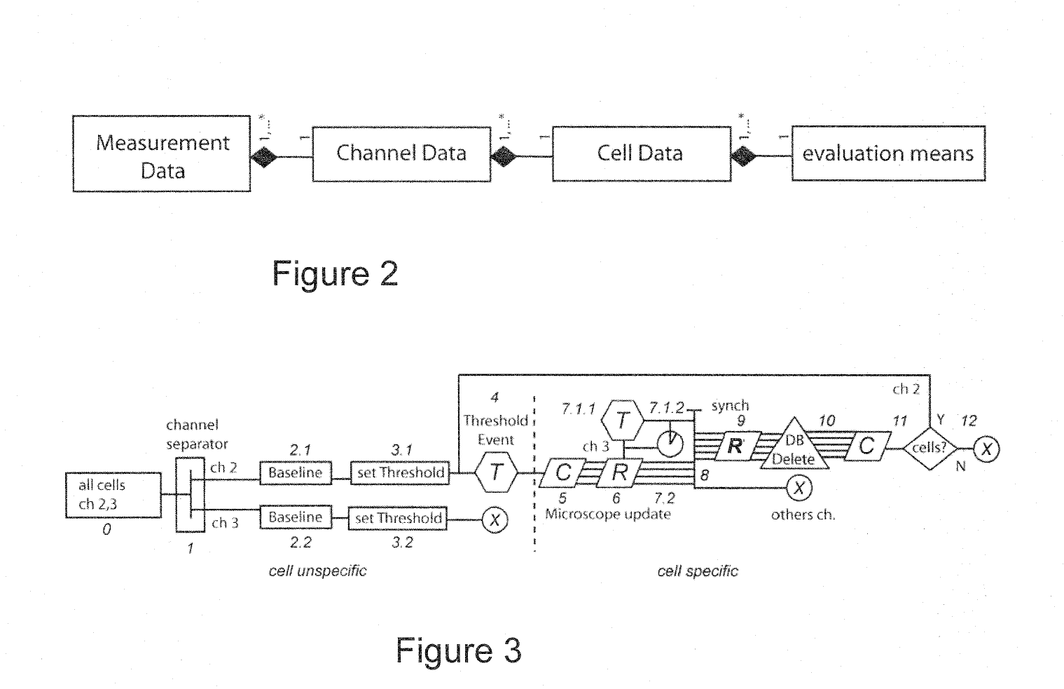

Referring now to FIG. 1, a system for automated control of laser microscopy according to a preferred embodiment of the present invention comprises three building blocks:
A Cellular Process Entity (CPE) is a tool that allows the assembly of basic building blocks of a measurement and detection process like thresholding, baseline detection, focusing, pausing, that can be combined into specific workflows. In the embodiment, the CPE includes a graphical user interface application, explained in more detail in relation to FIGS. 2 and 3, which enables a user to define the control of an experiment through a graphical framework. This definition is in turn used to produce logic, which is supplied to a base system to run the experiment.
A Base System provides image analysis modules that extract and track object e.g. cell or sub-cellular particle, related information and generate time series comprising multiple images for these objects. It further includes modules for processing and interpreting the logic generated by the CPE and sending control commands to a microscope. In summary, the base system executes the logic generated from the CPE, extracts the necessary information from the images provided by the microscope drivers and manages the communication with the microscope drivers. It is responsible for error handling, if any aspect of the logic, the image analysis or the microscope throws an exception.
A Microscope Driver acts as a service program to provide an open interface for any given microscope. The Driver allows the microscope to be controlled and specifically to be triggered to acquire new images (Service 1), change sampling rate/acquisition channels/magnification (Update Config) and other image modalities such as scanning region (ROI) (Service 2). The drivers comprise service programs (Service 1 and 2 etc) that get called by the hardware independent logic of the base system and translate this to machine specific commands.

Thus, the system architecture for the embodiment abstracts the automation logic (sequence of criteria, microscopy automation events and a decision logic for conflict resolution) from the base system (interpretation of this logic, image analysis) and likewise from the hardware (microscopy drivers). The first separation enables the system to be applied to a large class of applications. The second separation facilitates integration with legacy equipment from different vendors by keeping adaptation efforts confined to isolated drivers.

In the present specification, the term channel is used to for any combination of laser excitation and detection configuration available for image acquisition through the microscope.

The term cell is used for a bounded region of an image generally corresponding to a biological entity of interest. Individual cells can be identified within an image by any number of suitable means including for example variants of the Watershed Algorithm, including Meyer's Watershed Algorithm. Thus, within the base system, when a probe is first imaged, a pre-processing algorithm that includes segmentation is applied to identify the respective boundaries of groups of pixels, each group corresponding to a cell within the image. Cells initially identified can then be tracked from image to image and suitable alignment and morphing techniques can be applied to adjust cell boundaries from one image within a time series to another. Mitosis can also be handled as daughter cells are generated in a probe under test.

Referring now to FIG. 2 there is shown a universal modeling language (UML) diagram of a data structure used within the graphical framework component of the system of FIG. 1. As will be seen, the most detailed elements are shown on the left, so that for example, in a laser scanning microscope with several channels, each channel will contain an array of measurement data i.e. values for a set of pixels within the boundary of a cell over a series of images. For each individual cell, there is an array of channel data i.e. a respective image plane for each channel, and each evaluation mechanism comprises an array of cells, each cell including 1 or more channels, each with its own set of pixel information which can be used in the evaluation.

So for example an evaluation can be linked to a given cell, for a given set of channels and for the image information contained within the cell for those channels.

Based on the data structure of FIG. 2, a graphical user interface (GUI) application is provided within the CPE. In common with other graphical development kits for example Visual Studio or the like, a user is initially presented with a blank workflow window into which instances of the various controls for an experiment are to be added and interlinked. The user is also provided with a separate window showing the various controls, which can be selected for defining the workflow. Many of the various controls of the present embodiment are explained below in relation to FIG. 3.

Furthermore, on launching the GUI application, if it is not already doing so, the base system is requested to begin imaging a probe. When a first image is returned, as well as being displayed in a window of the GUI application, the image is analysed and one or more cells are identified within the image and displayed for the user in conjunction with the image. The various cells are continually tracked during imaging, each cell having an identifier that is used to form the basis for the tests of the workflow.

The graphical language underlying the operation of the graphical user interface comprises a user-defined network of boxes interlinked by lines. Lines represent data structures and boxes represent analysis steps, decisions or microscopy setup actions as will be explained in more detail below.

### Lines (Data Structure):

Lines represent data structures that get evaluated, manipulated or filtered by the boxes
Lines can represent the whole hierarchy or substructures of the data structure of FIG. 2. For example, a substructure could be data for all channels for a particular cell.

Boxes (Classes, Executable Code)
Boxes represent active units that operate on data and decide on actions for microscopy set-up. Data operation can be image analysis steps including setting threshold criteria, receiving threshold criteria, calculating baselines etc.
Logic for boxes operating on the same line is processed from left to right by the base system. Logic for boxes on parallel lines is processed concurrently.
Filtering: Boxes may use input data and generated output data of a lesser substructure in the hierarchy of FIG. 2 (e.g. data of a particular cell). For example, a box that waits for a threshold of all cells, filters the particular cell for when the threshold is actually reached. Any subsequent box operating on that line uses this particular cell as an input.
Splitting: Boxes may split data on the same hierarchical level, for example, split a channel into two measurement channels that are evaluated separately (but for all cells).
Customization: Boxes may be customizable by different parameters e.g. the user may right-click on a box within the workflow window to set its parameters. For example, a box that sets a threshold that needs to be checked may have the following parameters channel=“dye 1”, cell number=all, evaluation means=average intensity.
Threshold Event integration and decision logic: Boxes may collect and integrate thresholds.
Decision logic: Boxes can contain decision logic that integrates different event information and decides on appropriate actions (e.g. configuration updates). As noted above, decision logic is customizable so that different thresholds may be associated with different cells or channels.
Boxes can be combined into superboxes, so that they can more closely resemble more macroscopic biological situations.

FIG. 3 shows a sample illustration of a workflow window for an experiment within the GUI application outlined above. Italicised numbers refer to node numbers and as well as text not appearing in boxes, these would not necessarily be included in the user interface presented to a user when running the application and defining the control parameters for an experiment.

The following description of the various lines and boxes of FIG. 3 demonstrate the way the decision logic is performed and how the data structure is manipulated. Nonetheless, it will be appreciated that scope of the invention is not limited to either the detailed semantics or their graphical representation. Referring to the Figure:
Box 0 enables user to specify in conjunction with an initial pre-processed image returned by the base system, the cells and channels, which are of initial interest for a given experiment. In this case, two channels, each comprising a respective excitation and detection channel, for all detected cells will be tracked at least initially by the base system.
A channel separator (box 1) can separate channels for detached evaluation of the selected cells on channels 2 and 3 from box 0.
A time series separator (not shown) can separate time series of one channel for different means of evaluation.
A baseline box (box 2.1 and 2.2) calculates a baseline (stable line) of a time series that is associated to the respective (ingoing) channel and to selected ingoing cells. (A regression procedure may be applied, by looping back to such boxes). The box is executed when a baseline is ready i.e. a number of images may need to be analysed and tracked before a baseline is available for the selected cells on the selected channels. A customization parameter set by the user, preferably by clicking on a baseline box, indicates the type and quality of the baseline for targeted cells/channels.
A “set Threshold” box (box 3.1 and 3.2) sets a threshold (receipt of the Threshold not part of this entity) for all ingoing channels, cells and evaluation means. Thresholds are calculated relative to the ingoing baseline and the user must also specify the direction of the threshold (exceed or undergoing).
A threshold event entity “T” (box 4 and 7.1.1) indicates if an ingoing time series exceeds the desired threshold relative to a given baseline for the current image. As such, “T” boxes:
   1. cause the base system to continually evaluate incoming time series images until a threshold is met before enabling the logic to proceed.
   2. act as dynamic selectors as they select the ingoing channels, ingoing cells and ingoing time series from the initially selected cells (box 0). So as mentioned above, if all cells are being monitored, only the cell/channel meeting the threshold is output for further processing.
   3. act as consolidators that simultaneously resolve received thresholds for a given image. The threshold entity box can be customized, again through user selection of parameters available for a given instance of control, to apply a logic that can prioritize cells and channels according certain predefined means and actual threshold data (e.g. take cell with actual value that is closest to the threshold)
A Stop entity “X” (not labeled) stops the workflow for the respective input (a channel, a cell or a means of evaluation or a combination). However, the base system does not stop time series generation and thresholds are remembered for future iterations involving a given channel.
A Microscope configuration update entity “C” (boxes 5 and 11) that allows the microscope to be updated after a threshold is reached. It allows for example (but not exclusively):
   1. the image acquisition rate to be changed;
   2. further channels to be switched on/off;
   3. imaging to change from 2-D to stacked 3-D imaging; or
   4. even for a sample to be changed, if automatic change is available for the microscope, as for example in HCS (High Content Screening) applications.
Outgoing lines from a configuration update entity refer to the new resources. If a channel is switched on after it has been suspended, threshold data are reloaded.
Microscope update entity “R” (boxes 6 and 9) enable a user to define regions of interest (ROI) to be subsequently scanned in association with an ingoing cell. It will be appreciated that scanning an entire image may unnecessarily consume time and resources and also increase the possibility of phototoxicity. Employing an R box enables a user to specify that a scanning area be limited to a rectangle bounding a cell, which has met a given threshold as in the case of node 6. Alternatively, in the example of FIG. 3, the R box of node 9 can be used to expand the ROI to cover all originally detected cells (box 0) after the second threshold for the first cell to meet the threshold at node 4 has been met or timed out (explained below). As such, the workflow of FIG. 3, enables an experiment to zoom in on a first cell/channel to meet a threshold, monitor that cell/channel for up to a given time for second threshold and then zoom out before continuing to monitor for the same event in other cells.
A timer entity (box 7.1.2) that allows the workflow to proceed in the absence of a threshold event occurring. In FIG. 3, channel 3 for a given cell is being monitored at node 7.1.1. However, if the threshold is not met within a time set at the node 7.1.2, the process continues as explained below. In other implementations, a timer box could be used between one configuration C box and another, simply to turn on/off certain channels for a specific period of time.
Synchronization boxes (box 8) allow synchronizing of measurements for different channels, cells or time series when thresholds for particular ones are pending. In FIG. 3, a region specified at node 6 has several active channels (7.2), which are not the subject of any thresholds, whereas only channel 3 is the subject of the threshold at node 7.1.1. In this case the channels 7.2, can for example, be used to excite the cell in the context of an experiment analyzing Fluorescence Recovery after Photo Bleaching (FRAP) or Fluorescence Loss in Photobleaching (FLIP). Likewise, an inactive compound can be rendered active by illumination with high intensity laser light of short wave length through photoactivation (“un-caging”). As mentioned in the introduction, additional modes of operation can be run depending on the microscope hardware available.
A Data Base Delete (box 10) that allows deletion of cells, channels or evaluation means from a repository of images stored by the base system. Again, the information to be deleted is determined by the particular parameters set for the instance of box—for example, the images for all but channel 3 for the cell being monitored could be deleted.
A box “Cells?” (box 12) that reloads threshold and status data from the data base, performs a status update (post-processing) and (re-)assigns the cells for processing. A similar box “Channels?” (not shown) works in the same way. The box provides two outputs, one if cells other than the previously detected cell are found, and the other if no further cells could be found. In the example of FIG. 3, the experiment continues by monitoring for the previous threshold event on channel 2 only.
A Redirect node (not shown) can also be provided for iterations as well as logical queries that check for conditions on channels, cells and time series.

Within the user interface, any of the above entities can be selected and added to an experiment definition, with the relevant properties for each entity set as required.

Furthermore, the GUI application preferably provides user interface devices, for example, select buttons, which enable instances of controls to be combined into more complex entities that are assigned to separate icons with user specified names. These entities can then closer resemble biological situations. Therefore, they can be re-used as building blocks customized for experimental needs. As an example, the boxes 0-3 in FIG. 3 could be associated to a box, “detect enzyme activation in cell” and boxes 4-8 could be combined in a box, “measure detailed catalytic rate of enzyme in the respective cell”.

In other variants of the graphical framework and GUI application, other events besides thresholds (signal loss, cell area shrinkage, etc) may also be processed. Also, boxes could be independent processes (i.e. code entities) that are chained by pointers. As mentioned previously, the graphical representation for an experiment defined within the user interface could be translated to an XML based scheme to make it inter-changeable with other base systems or to provide the basis for a standard in this field.

It will also be seen that the controls available through the graphical framework and especially the configuration update entity C box can be extended or indeed additional user interface controls provided to enable experiments to be configured for applications in, for example: epifluorescence microscopy imaging; high content screening (HCS), where robotic sample handing is available; Fluorescence correlation spectroscopy (FCS), if this is available on microscope hardware; or Fluorescence Lifetime Imaging Microscopy (FLIM) again, if this is available on microscope hardware.

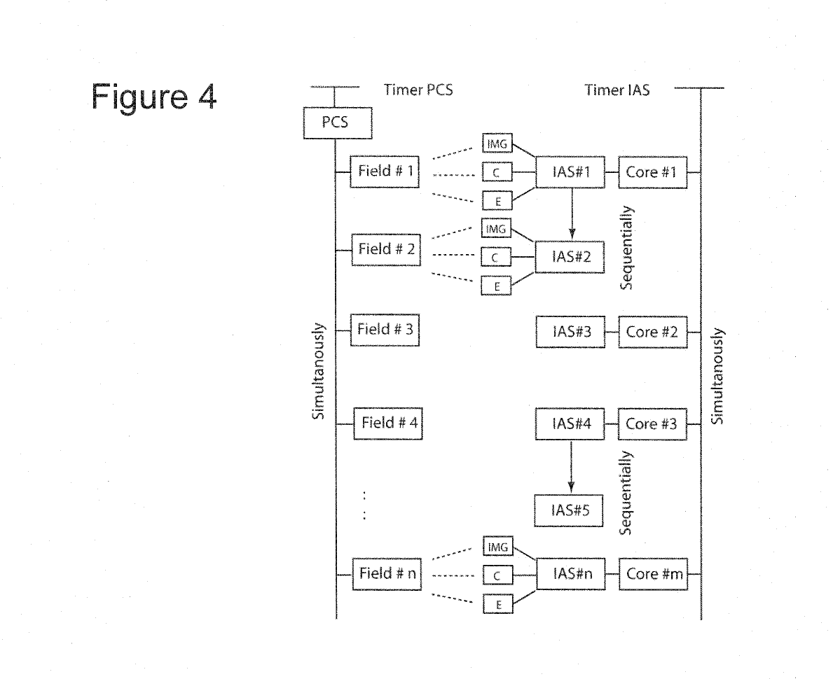

FIG. 4 shows a schema for simultaneous handling of multiple positions within the Base System of FIG. 1. The image analysis tasks of each position are managed by an entity denoted as Image Acquisition Support (IAS). IAS entities for different fields work independently from each other and exchange images (IMG), receive task information (C) from and report completion (E) to a process control screener (PCS). IAS entities may work on the same or different computers or core processors. Preferably, the PCS comprises a single unit per system and integrates and synchronizes the information through a Field-handler from all IAS entities and executes settings via the microscope drivers.

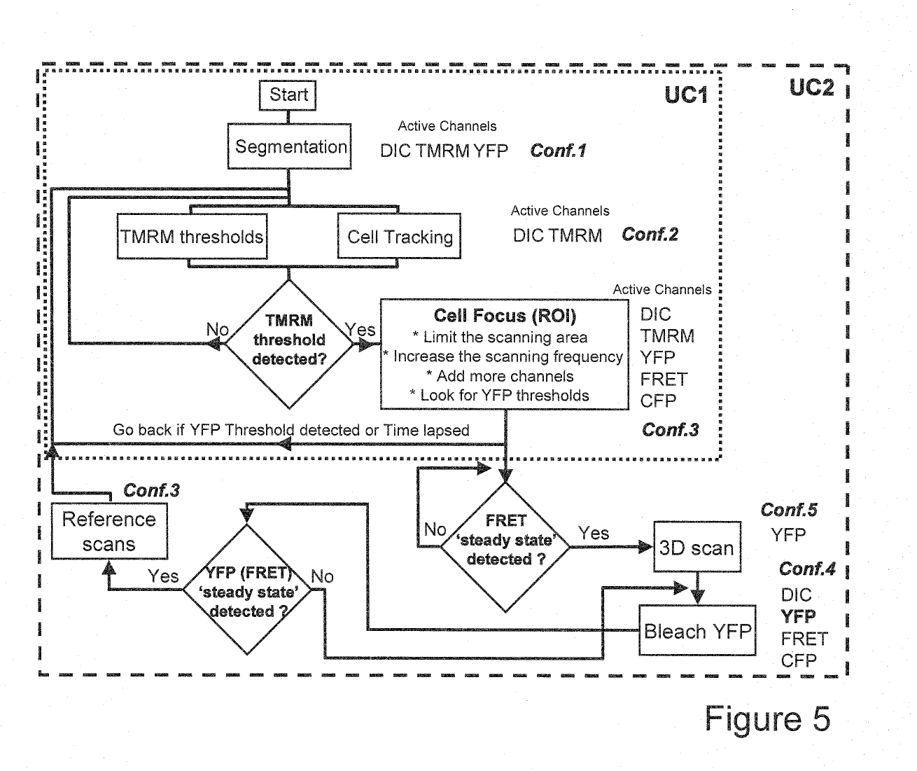

FIG. 5 shows an example that studies neurons for five different imaging channels (DIC), ‘TMRM’ for studying the mitochondrial membrane potential ΔΨₘ, and the channels ‘YFP’ used for tracking, ‘CFP’ and ‘FRET’ for detection of enzyme activation characterising neuronal viability after detected changes in ΔΨₘ. The purpose of the experiments is to study the latter three parameters, and to quantify them absolutely after detected events of TMRM have occurred. Therefore, cell segmentation is performed and neurons are stimulated with a drug (Staurosporine (STS)). A change of the average TMRM intensity of 20% below a pre-calculated baseline for one of the segmented neurons triggers the individualized imaging for those neurons. This consists of rapid sampling at a temporal rate of 15 seconds using high energy lasers for CFP, YFP and FRET channels, and is performed on a region limited just to this cell area. Image acquisition is then temporarily suspended for other fields of view and other cells of the same field. This proceeds until the FRET channel is stable. 3-D (z-stack) scanning of the respective neuron is subsequently performed to investigate changes of neuronal morphology. Then photobleaching is performed to study remnant CFP, YFP and FRET levels (i.e. compare them to a completely bleached signal). The procedure is subsequently triggered for other neurons if their ΔΨₘ (TMRM) indicates a signal below threshold.

The invention is not limited to the embodiment(s) described herein but can be amended or modified without departing from the scope of the present invention.

1. A method for controlling laser scanning microscopy of a probe comprising at least one cell, the method comprising the steps of:
acquiring at least one initial image of said probe;
identifying at least one cell within an initial probe image;
using a pre-defined grammar, providing: a first set of scanning mode parameters for monitoring said at least one cell; a first set of trigger parameters including at least one physiological parameter defining an event in said at least one cell; and a second set of scanning mode parameters for monitoring at least one cell of said probe after an occurrence of said event;
providing a successive set of probe images acquired according to said first set of scanning mode parameters;
processing said successive images to determine if said event has occurred; and
responsive to said event occurring, changing to said second set of scanning mode parameters.

2. A method according to claim 1 wherein said scanning mode parameters include excitation and detection parameters.

3. A method according to claim 2 wherein said scanning mode parameters define: one or more regions of interest to be scanned; scanning channel parameters; scanning magnification; image acquisition rate; 2-dimension or 3-dimension image acquisition; or change of sample.

4. A method according to claim 1 wherein said processing comprises tracking identified cells within said successive images including aligning and morphing cell boundaries.

5. A method according to claim 1 wherein said trigger parameters include a baseline measurement for a cell and a threshold change relative to said baseline measurement for said cell.

6. A method according to claim 1 wherein said trigger parameters include a time delay.

7. A method according to claim 1 wherein said threshold comprises a defined change in: average, standard deviation or total cell intensity; or a defined change in distribution or patterns of cell within a probe.

8. A method according to claim 1 wherein said physiological cell parameters include: cell fluorescence or cell size.

9. A method according to claim 1 comprising any one of the steps of: adding scanning channels, increasing image acquisition rate; increasing image magnification; or increasing scanning area in response to a trigger event.

10. A method according to claim 1 comprising analyzing a probe for Fluorescence Recovery after Photo Bleaching (FRAP) or Fluorescence Loss in Photobleaching (FLIP) according to the steps of claim 1.

11. A method according to claim 1 wherein said grammar is arranged to enable a user to provide a plurality of sets of trigger parameters defining respective events in cells of said probe; and a plurality of sets of scanning mode parameters for monitoring cells of said probe after an occurrence of a specified event; said method comprising, iteratively:
providing a successive set of probe images acquired according to said one of said set of scanning mode parameters;
processing said successive images to determine if a specified event has occurred; and
responsive to said specified event occurring, changing to another set of scanning mode parameters.

12. A method according to claim 1 wherein said microscopy comprises one or more of epifluorescence microscopy imaging; high content screening (HCS); Fluorescence correlation spectroscopy (FCS); or Fluorescence Lifetime Imaging Microscopy (FLIM).

13. A method according to claim 3 wherein said scanning mode parameters define a plurality of regions of interest including one of: overlapping or non-overlapping regions corresponding to respective fields of view of said probe.

14. A method according to claim 1 wherein said grammar includes respective commands relating to regions of interest; and commands for co-ordination of microscope modality.

15. A method according to claim 14 comprising processing commands relating to regions of interest on a first set of computing devices; and processing commands for co-ordination of microscope modality on a single central computing device.

16. A computer program product comprising a computer readable medium on which computer readable instructions are stored, which when executed control laser scanning microscopy of a probe comprising at least one cell according to the steps of claim 1.

17. A computer program product according to claim 16 including a graphical user interface application which is responsive to user interaction to provide said first and second sets of scanning mode parameters and said first set of trigger parameters.

18. A computer program product according to claim 17 comprising one or more microscope drivers arranged to control a variety of laser microscopes according to a common language.

19. A computer program product according to claim 18 comprising a process independent and hardware independent layer which is use us arranged to interpret said scanning mode parameters and said trigger parameters and to control said microscope drivers accordingly.

20. A computer program product according to claim 18 wherein said microscope drivers comprise means for: requesting an image from a microscope, defining a scanning region of interest; and for updating a configuration of said microscope.
